(19) United States
(12) Patent Application Publication
(10) Pub. No.: US 2010/0294611 A1
(43) Pub. Date: Nov. 25, 2010

(54) HYDRODYNAMIC MACHINE, IN PARTICULAR HYDRODYNAMIC RETARDER

(76) Inventor: Werner Adams, Crailsheim (DE)

Correspondence Address: FARJAMI & FARJAMI LLP, 26522 LA ALAMEDA AVENUE, SUITE 360, MISSION VIEJO, CA, 92691, US

(21) Appl. No.: 12/735,020

(22) PCT Filed: Sep. 26, 2008
(86) PCT No.: PCT/EP2008/008216

§ 371 Date: Aug. 5, 2010

(30) Foreign Application Priority Data
Dec. 17, 2007 (DE) 10 2007060 764.6

(51) Int. Cl. F16D 33/00

(52) U.S. Cl. 192/58.3

(57) ABSTRACT

The invention relates to a hydrodynamic machine, in particular hydrodynamic retarder,
with a bladed primary wheel, which is rotatable over an axis of rotation of the hydrodynamic machine, and a bladed secondary wheel which is stationarily or rotatable over the axis of rotation of the hydrodynamic machine, wherein
the primary wheel and the secondary wheel together form a toroidal working space which is filled or can be filled with working medium, and
the primary wheel has at least one inlet channel for the working medium.

The invention is characterised in that
the inlet channel runs within the torus wall and/or within a blade of the primary wheel and opens in the region of the centre or radially outside the centre between the outer radius and the inner radius of the blades of the primary wheel at a location in the region of the torus wall in the working space.

The invention relates to a hydrodynamic machine, in particular a hydrodynamic retarder according to the preamble of claim 1. The invention is however also applicable in a hydrodynamic coupling.

Hydrodynamic retarders and hydrodynamic couplings differ from a hydrodynamic converter in that they have just two blade wheels which together form a toroidal working space. Whereas in a hydrodynamic coupling both blade wheels revolve in the same direction of rotation, in a hydrodynamic retarder the blade wheel opposing the pump wheel is stationary or revolves in what is known as a counter retarder in the opposite direction to the pump wheel. In the hydrodynamic coupling, what is known as the turbine wheel moves in this case at a rotational speed which is lower than the rotational speed of the pump wheel, as slippage between the two blade wheels is required for transmitting torque from the pump wheel to the turbine wheel.

Hydrodynamic machines of the aforementioned type have been developed in a large number of embodiments. While they were firstly operated exclusively with the working medium oil, hydrodynamic retarders with water as the working medium, which are arranged for example directly in the vehicle cooling circuit, have recently been proposed. The selected working medium has an influence on the performance of the hydrodynamic machine or on the torque transmitted from the pump wheel to the turbine wheel and also on the heat which is formed as a result of the friction of the fluid. In order to be able to provide in retarders a particularly high braking effect, the transmitted power or the transmitted moment should be as high as possible; this is expressed in a high performance number λ. The performance number λ is known to the person skilled in the art for hydrodynamic machines and specified for example in Dubbel, Taschenbuch für den Maschinenbau.

In order to increase the performance number of a hydrodynamic machine, unpublished patent application DE 10 2007 060 764.6 has already proposed forming in the pump wheel an inlet channel which runs in the radial direction and extends perpendicularly or at an angle to the axis of rotation of the hydrodynamic machine. Nevertheless, filling out of the torus wall has not to date been applied without extraneous pressure, as the counterpressure is greatest on the torus wall, especially in an obliquely bladed circuit and at high slippage. The meridian velocity of the working medium is then a multiple of the circumferential velocity and the rotary pressure from the centrifugal acceleration of the meridian flow is relatively high.

In the past, obliquely bladed hydrodynamic circuits have therefore been filled in just two ways. If a high inflow pressure is available, filling takes place through the inner or outer gap between the pumps and turbine wheel. Otherwise, this takes place via closed channels which run into the centre of the torus. This requires a high inflow pressure to be generated in a complex manner and channels into the centre of the torus cost money and performance number λ.

The object of the present invention is to specify a hydrodynamic machine and in particular a hydrodynamic retarder in which the transmission of power or torque from a driven primary wheel to an opposing secondary wheel is improved in a simple, efficient and cost-effective manner.

This object is achieved by a hydrodynamic machine having the characterising features of claim 1. The dependent claims describe particularly advantageous and expedient configurations of the invention.

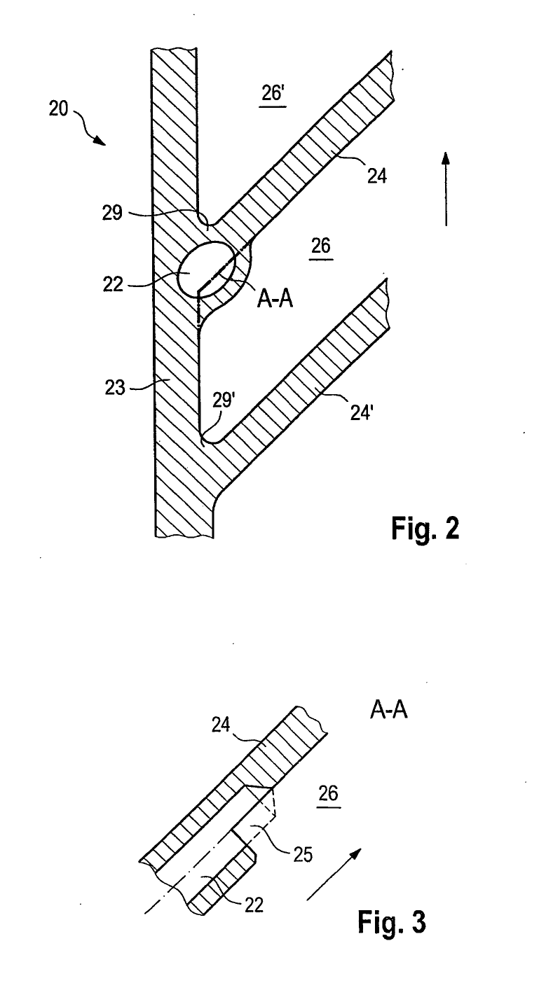

The invention starts in this case from the finding that the rotary pressure is not uniformly high across the torus wall, in particular in an obliquely bladed hydrodynamic machine. In an obliquely bladed hydrodynamic machine of this type, such as the present invention according to an embodiment relates to, the blades of the primary wheel and/or the secondary wheel run in planes lying at an angle, that is to say not perpendicularly, to a plane formed by the separating gap between the primary wheel and secondary wheel. Obliquely bladed hydrodynamic machines of this type are known to the person skilled in the art and will be presented hereinafter with reference to FIG. 2.

On account of the oblique blading and the oblique positioning resulting therefrom of the meridian flow, the torus wall on the non-bladed side of a blade is positioned radially further inward and thus experiences a lower rotary pressure. The lines of equal pressure tend to run perpendicularly to the blade faces. On the other hand, the flow in the rotor is guided, viewed from the primary wheel, radially outward and must therefore increase in the circumferential direction of rotation (twist). Nevertheless, the law of free flow states that the flow would however decrease in the circumferential direction of rotation during radial ‘outward flow’. This effect increases the pressure on the side of the ‘sliding blade’ and the lines of equal pressure no longer run perpendicularly to the blade faces, but are inclined still further toward the torus wall.

In a rotor of the hydrodynamic machine, this is utilised to the benefit of the invention in that the at least one inlet channel is guided in such a way that it opens into the especially low-pressure area positioned directly after a blade in the working space (in the direction of rotation of the primary wheel, on the side of the blade that is remote from the direction of rotation) and/or opens, based on the radial direction of the hydrodynamic machine, on a radius in the region of the torus wall that is positioned in the region of the centre or radially outside the centre between the outer radius and the inner radius of the blade of the primary wheel. The term “in the region of the torus wall” means in this case in an opening in the region of the centre between the outer radius and the inner radius of the blade in the axial direction of the hydrodynamic machine outside the separating gap between the primary wheel and secondary wheel, in particular in the region of the bottom of the blade wheel at the axial end of the blade, the axial end being remote from the free end of the blade. In the case of an opening in the region of the outer radius or on the outer radius of the blade, on the other hand, the opening is positioned roughly or exactly in the separating gap.

This allows the working space to be filled at high throughput and without extraneous pressure.

Starting from the finding that the rotary pressure is produced from the centrifugal acceleration of the meridian flow as a result of the deflection of the working medium on the radius of the torus wall, an area of relatively low pressure can in this case also be produced in the torus by targeted configuration of the torus and/or the blading. An area of relatively low pressure in the torus can therefore be produced in that a respective blade and/or the torus wall of the primary wheel is/are configured in the region of the opening of an inlet channel so as to be radii-free or low-radii to the extent that a substantially obstacle-free, rectilinearly running flow is formed in this region. As a result, the deflection is interrupted by means of a straight section through which what is known as the Venturi effect of the meridian flow sweeping past becomes most effective. The straight section can be prolonged in that the radii are selected so as to be all the narrower at other locations.

A blade space formed between each pair of blades may in this case analogously be regarded as a flow channel which is closed off per se. However, that means that a relative widening of its flow cross section will produce a zone of relative reduced pressure. Preferably, this is achieved in that the blades and/or the torus wall of the primary wheel is/are configured and/or oriented in such a way that at least one blade space formed by opposing blades and the torus wall positioned therebetween has a flow cross section which is narrower or wider in relation to the flow cross section of an adjacent blade space. According to the invention, such a configuration supports the inflow of the working medium into the blade channel and thus into the torus space. In principle, this can take place in each blade space.

Alternatively or additionally, the (relative) enlargement of the flow cross section can take place in that, in the viewing direction of the axis of rotation, the leading edge of a blade is oriented in such a way that its imaginary prolongation rests tangentially against a first circle around the axis of rotation and the leading edge of an adjacent blade is oriented in such a way that its imaginary prolongation rests tangentially against a second circle around the axis of rotation and the intersecting or non-intersecting of the two prolongations before a point of contact with the circle produces a flow cross section which is narrower or wider compared to a flow cross section which would be produced in the case of prolongations each running through the axis of rotation. For example, this changes the direction of alignment of every other blade, i.e. each even-numbered blade has a different angle of alignment to each odd-numbered blade. Thus, every other or x^{th} blade space in the direction of flow of the working medium experiences a relative widening or enhancement of the V shape, while the other blade spaces in the direction of flow experience a relative narrowing.

A particularly marked alteration of the flow cross section across the blade spaces is achieved in that the diameter of the second circle is the same size as or larger than the diameter of the first circle. The blade which is oriented on the second circle narrows in this case the corresponding flow cross section to the degree to which the second circle is larger than the first circle.

If the blade spaces which follow on from one another in the circumferential direction have alternately narrow and wide flow cross sections, an oscillation excitation of the rotor may be suppressed and its acoustic behaviour thereby improved. In addition, jumps in the characteristic curve of the rotor are avoided. This also applies in particular to a screwed profile. A screwed profile of this type is a profile which can be produced by die casting, in particular pressure die casting, wherein the blade wheel can be removed from the mould by rotation without destroying the casting mould.

The suction effect and the increase in power associated therewith of the hydrodynamic machine is in this case greatest if the at least one inlet channel for the working medium leads into a respective blade space having a wide flow cross section. It is also possible for the inlet channel to open at a location in the working space at which a blade space formed by opposing blades in the direction of rotation of the primary wheel and the torus wall positioned therebetween to have a flow cross section which widens relatively more markedly in relation to the flow cross section of an adjacent blade space which is in particular free of an opening of an inlet channel. This relatively more marked widening can be locally confined or continue over the entire blade space of the primary wheel. If all the relatively widening flow channels are supplied with inlet channels, a comprehensive supply with working medium is ensured.

The power can also be increased in that the primary wheel has a rear-side blading which is configured and/or oriented in such a way that, on rotation of the primary wheel, a working medium located in the surroundings thereof is set in motion and supplied to the at least one inlet channel. This corresponds to a pressurised supply of the working medium without thereby requiring an additional pump.

A further increase in power is possible if the at least one inlet channel is oriented at an angle to the axis of rotation and in particular runs from the inside toward the outside with regard to its guiding of working medium in the radial direction. The centrifugal force acting on the working medium improves the supply of the working medium into the working space. At the same time, channels arranged in this way may be manufactured more effectively, as the rotor can be machined from the oblique interior.

For reasons of stability, it is preferred if the at least one inlet channel runs in the base of a blade. This base is generally sufficiently strong to accommodate the channel without the rotor losing strength. In addition, attaching the channel at this location allows the influencing of the flow to be limited or avoided altogether. The base could also be referred to as a blade foot.

The present invention will be described hereinafter in greater detail based on exemplary embodiments and with reference to the enclosed figures. Like or equivalent parts are provided with like reference numerals. In the drawings:

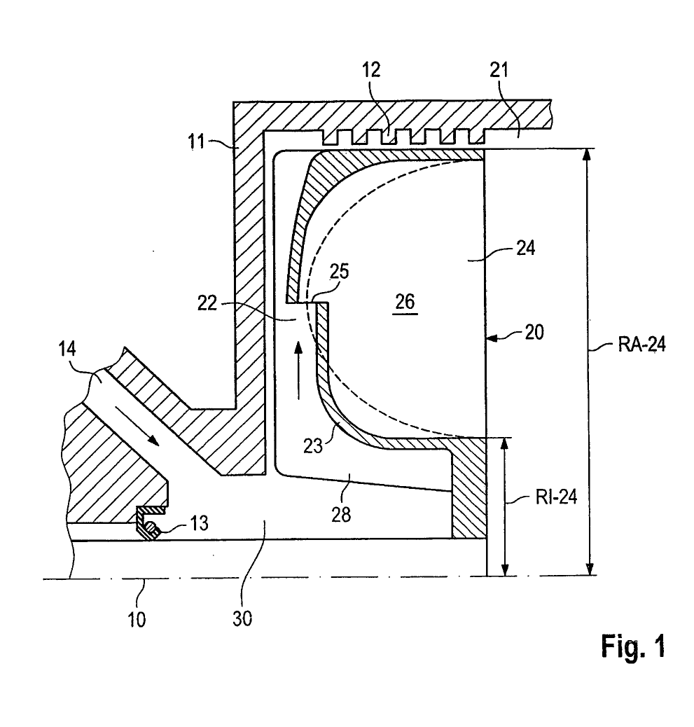

FIG. 1 shows a part of a hydraulic machine according to the invention in a section along the axis of rotation with a primary wheel arranged therein;

FIG. 2 shows a part of the primary wheel from FIG. 1 in a section perpendicular to the blades running therein; FIG. 3 shows the opening of the inlet channel in section A-A from FIG. 2 in the low-pressure area of the blade space;

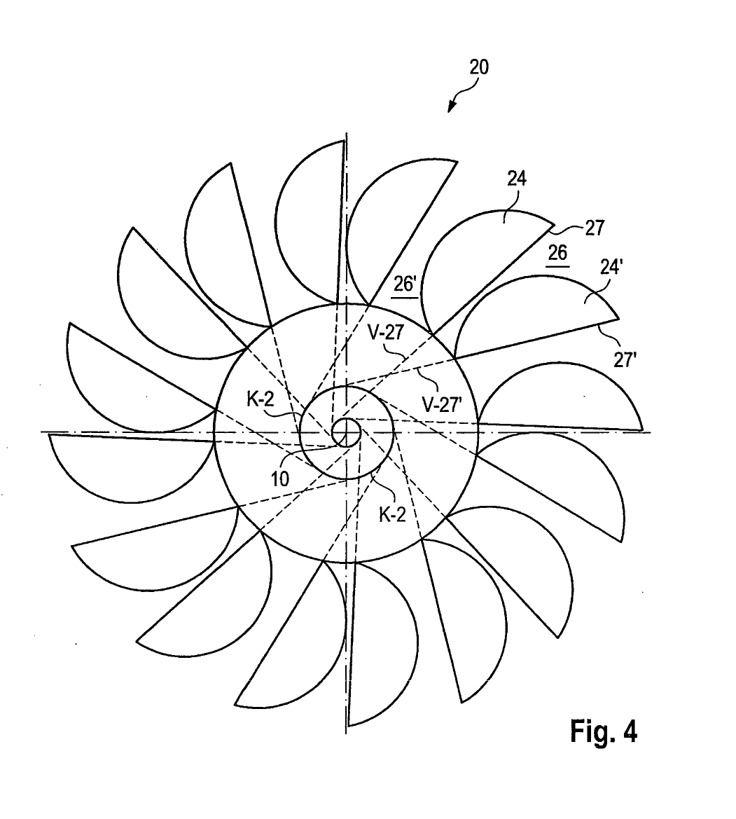

FIG. 4 shows the respective orientation of the revolving blades in the primary wheel from FIG. 1; and

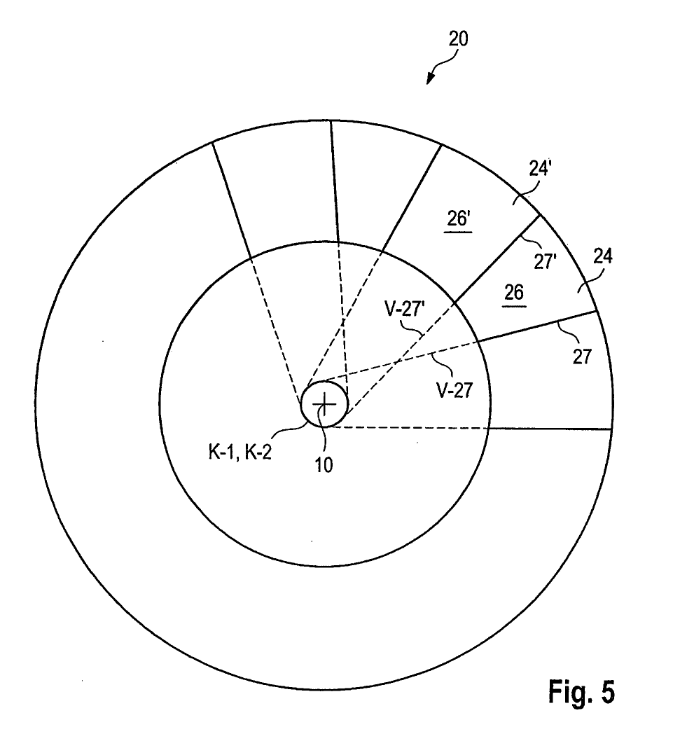

FIG. 5 shows an alternative orientation of the revolving blades in the primary wheel from FIG. 1.

FIG. 1 shows a part of a hydraulic machine according to the invention in a section along the axis of rotation 10 with a primary wheel 20 arranged therein. The primary wheel 20 is in this case mounted in a housing 11 of the machine, the housing providing a gap seal 12 from the outer side of the primary wheel 20. In addition, an axial seal 13 is attached between the axis of rotation 10 and housing 11. A working medium 30, which is drawn into the toroidal working space 21 of the machine via an inlet channel 22 in the torus wall 23 of the primary wheel 20 as soon as the primary wheel rotates, is introduced (in the direction indicated by the arrow) into the space thus created via an inflow 14. The inlet channel 22 is attached in the torus wall 23 so as to run radially from the inside toward the outside in order to centrifugally assist the supply of the working medium 30. The inlet channel 22 opens roughly halfway up between the outer diameter RA-24 (radius outside) and inner radius RI-24 (radius inside) of the primary wheel 20 and in this case, in the directioh of movement of the primary wheel 20, after a blade 24 arranged therein. A relative reduced pressure prevails in this area on rotation of the primary wheel, so that pressurised supply of the working medium 30 is not necessary. In addition, the opening 25 of the inlet channel 22 is arranged in a radii-free, straight section in the blade space 26 in order to fully utilise there the Venturi effect of the flow as it sweeps past. A conventional torus contour, which does not have a radii-free section of this type, is indicated by dashed lines for comparison of the contour guidance according to the invention. Both measures according to the invention, the guidance of the inlet channel 22 into an area which is as low-pressure as possible and the configuration of the torus wall 23 and/or the blades 24, 24′, can be used, as shown here, in conjunction with each other or else alternatively to each other in order to achieve an increase in power of the machine as a result of better filling.

In the embodiment of the machine according to the invention as shown in FIG. 1, a rear-side blading 28 of the primary wheel 20 supports the supply of the working medium 30. This blading 28 is configured and attached in such a way that the working medium 30 is supplied to the inlet channel 22 on rotation of the primary wheel 20. A blading of this type can, but does not have to be, provided in order to ensure a sufficient supply of working medium.

FIG. 2 shows a part of the primary wheel 20 from FIG. 1 in a section perpendicular to the blades 24, 24′ running therein. This figure shows the guidance of the inlet channel 22 for the working medium 30 in a base 29, 29′ of the blades 24, 24′. As a result of this guidance of the channel 22; the stability of the primary wheel 20 is maintained, as there is sufficient material between the blades 24, 24′ and torus wall 23 to accommodate the primary wheel. The direction of movement of the primary wheel 20 is marked by the arrow. The working medium, which is already located in the blade space 26 or 26′ as part of the working space, flows along the torus wall 23 of the primary wheel 20 out of the drawing plane in the illustration shown. The low-pressure zone in the torus of a respective blade space 26, 26′ is located in the region of the surface of each blade 24, 24′ that is remote from the direction of movement.

As may be seen, the primary blade wheel shown in FIG. 2 is an obliquely bladed blade wheel, as the blades 24, 24′ are positioned not perpendicularly, but at an inclination on the bottom of the blade wheel or the torus wall 23.

FIG. 3 shows the opening 25 of the inlet channel 22 in section A-A of FIG. 2 in the low-pressure area of the blade space 26. For reasons of simple manufacture, the inlet channel 22 is in this case designed as a bore in the blade 24. It is of course also conceivable to produce the channel 22 by die casting, although this will be much more expensive. The Venturi effect of the working medium sweeping (in the direction indicated by the arrow) past the opening 25 over a long straight section exerts on the working medium 30 a suction which promotes entry of the working medium into the blade space 26.

FIG. 4 shows a respective orientation of the revolving blades 24, 24′ in the primary wheel 20, for example a wheel of the type such as is shown in FIG. 1. Imaginary prolongations V-27, V-27′ of the respective leading edges of the blades 24, 24′ rest in this case tangentially against a respective small and large circle K-1, K-2 around the axis of rotation 10 of the machine, so that they intersect before the point of contact with the respective circle. This takes place between opposing pairs of blades 24, 24′ in such a way that continuous blade spaces 26, 26′ having alternately narrower and wider flow cross sections are formed. On rotation of the primary wheel 20, a relatively lower pressure prevails in the wider blade spaces 26′ than in the narrower blade spaces 26, so that the former can be equipped with corresponding inlet channels 22.

FIG. 5 shows an alternative respective orientation of the revolving blades 24, 24′ in the primary wheel 20 from FIG. 1. In this case, the circles K-1, K-2 around the axis of rotation 10 are selected so as to be the same size, allowing a particularly simple design orientation of the blades 24, 24′. The prolongations V-27, V-27′ of the leading edges 27, 27′ of adjacent blades 24, 24′ rest tangentially against a respective side of the circle K-1, K-2, the prolongations intersecting before their respective point of contact with the circle. The blade space 26 positioned therebetween therefore experiences a narrower flow cross section, whereas the subsequent blade space 26′ has a wider cross section. The latter is in turn followed by a narrower cross section, etc. In this alternative orientation of the blades 24, 24′ too, the narrower and thus lower-pressure blade spaces 26 can be supplied with corresponding inlet channels 22 in order to ensure a supply of the working medium 30 without additional pressurisation. At the same time, making the spaces 26, 26′ alternately wide and narrow has a vibration-damping and thus noise-reducing effect. At the same time, jumps in the characteristic curve of the rotor are avoided, even in a screwed profile.

Advantageously, at least one outlet channel, via which working medium flows out of the hydrodynamic machine, can open in a region of comparatively high pressure. This may for example be in the comparatively narrower blade spaces 26 and/or on the respective front, based on the direction of movement, of the blades in the primary wheel or secondary wheel of the hydrodynamic machine.

### LIST OF REFERENCE NUMERALS

K-1, K-2 circles around axis of rotation 10

RI-24 inner radius of the blade 24

RA-24 outer radius of the blade 24

V-27, V-27′ prolongations of the leading edges 27, 27′

10 axis of rotation of the hydrodynamic machine

11 housing of the machine

12 gap seal

13 axial seal

14 inflow for working medium

20 primary wheel of the machine

21 toroidal working space of the machine

22 inlet channel for working medium 30

23 torus wall of the primary wheel 20

24, 24′ blades of the primary wheel 20

25 opening of the inlet channel 22 in the working space 21

26 blade space

27, 27′ leading edges of the blades 24, 24′

28 rear-side blading

29, 29′ base of the blades 24, 24′

1-13. (canceled)

14. A hydrodynamic machine, in particular hydrodynamic retarder,
with a bladed primary wheel, which is rotatable over an axis of rotation of the hydrodynamic machine, and a bladed secondary wheel which is stationarily or rotatable over the axis of rotation of the hydrodynamic machine, wherein the primary wheel and the secondary wheel together form a toroidal working space which is filled or can be filled with working medium, and the primary wheel has at least one inlet channel for the working medium, wherein
the inlet channel runs within the torus wall and/or within a blade of the primary wheel and opens in the region of the centre or radially outside the centre between the outer radius and the inner radius of the blades of the primary wheel at a location in the region of the torus wall in the working space; and
a respective blade and/or the torus wall of the primary wheel is/are configured and/or oriented so that at least one blade space formed by opposing blades and the torus wall positioned therebetween has a flow cross section which is narrower or wider in relation to the flow cross section of an adjacent blade space;
characterised in that the at least one inlet channel for the working medium leads into a respective blade space having a wide flow cross section.

15. The hydrodynamic machine according to claim 14, characterised in that the inlet channel opens in the region of a surface, remote from the direction of rotation of the primary wheel, in the torus wall or on a surface, remote from the direction of rotation of the primary wheel, of the blade of the primary wheel in the working space.

16. The hydrodynamic machine according to claim 14, wherein a respective blade and/or the torus wall of the primary wheel is/are configured in the region of the opening of an inlet channel so as to be radii-free or low-radii so that a substantially obstacle-free, rectilinearly running flow is formed in this region.

17. The hydrodynamic machine according to claim 14, characterised in that, in the viewing direction of the axis of rotation, the leading edge of a blade is oriented in such a way that its imaginary prolongation rests tangentially against a first circle around the axis of rotation and the leading edge of an adjacent blade is oriented in such a way that its imaginary prolongation rests tangentially against a second circle around the axis of rotation and the intersecting or non-intersecting of the two prolongations before a point of contact with the circle produces a flow cross section which is narrower or wider compared to a flow cross section which would be produced in the case of prolongations each running through the axis of rotation.

18. The hydrodynamic machine according to claim 17, characterised in that the diameter of the second circle is equal to the diameter of the first circle and the two prolongations intersect before a point of contact with the circle.

19. The hydrodynamic machine according to claim 17, characterised in that the diameter of the second circle is larger than the diameter of the first circle.

20. The hydrodynamic machine according to claim 14, characterised in that the blade spaces which follow on from one another in the circumferential direction have alternately narrow and wide flow cross sections.

21. The hydrodynamic machine according to claim 14, wherein the primary wheel has a rear-side blading which is configured and/or oriented in such a way that, on rotation of the primary wheel, a working medium located in the surroundings thereof is set in motion and supplied to the at least one inlet channel.

22. The hydrodynamic machine according to claim 14, wherein the at least one inlet channel is oriented at an angle to the axis of rotation and in particular runs from the inside toward the outside with regard to its guiding of working medium in the radial direction.

23. The hydrodynamic machine according to claim 14, wherein the at least one inlet channel runs in the base of a blade.

24. The hydrodynamic machine according to claim 14, characterised in that the inlet channel opens at a location in the working space at which a blade space formed by opposing blades in the direction of rotation of the primary wheel and the torus wall positioned therebetween has a flow cross section which widens relatively more markedly in relation to the flow cross section of an adjacent blade space which is in particular free of an opening of an inlet channel.

25. The hydrodynamic machine according to claim 15, characterised in that, in the viewing direction of the axis of rotation, the leading edge of a blade is oriented in such a way that its imaginary prolongation rests tangentially against a first circle around the axis of rotation and the leading edge of an adjacent blade is oriented in such a way that its imaginary prolongation rests tangentially against a second circle around the axis of rotation and the intersecting or non-intersecting of the two prolongations before a point of contact with the circle produces a flow cross section which is narrower or wider compared to a flow cross section which would be produced in the case of prolongations each running through the axis of rotation.

26. The hydrodynamic machine according to claim 16, characterised in that, in the viewing direction of the axis of rotation, the leading edge of a blade is oriented in such a way that its imaginary prolongation rests tangentially against a first circle around the axis of rotation and the leading edge of an adjacent blade is oriented in such a way that its imaginary prolongation rests tangentially against a second circle around the axis of rotation and the intersecting or non-intersecting of the two prolongations before a point of contact with the circle produces a flow cross section which is narrower or wider compared to a flow cross section which would be produced in the case of prolongations each running through the axis of rotation.

27. The hydrodynamic machine according to claim 25, characterised in that the diameter of the second circle is equal to the diameter of the first circle and the two prolongations intersect before a point of contact with the circle.

28. The hydrodynamic machine according to claim 26, characterised in that the diameter of the second circle is equal to the diameter of the first circle and the two prolongations intersect before a point of contact with the circle.

29. The hydrodynamic machine according to claim 25, characterised in that the diameter of the second circle is larger than the diameter of the first circle.

30. The hydrodynamic machine according to claim 25, characterised in that the diameter of the second circle is larger than the diameter of the first circle.

31. The hydrodynamic machine according to claim 15, characterised in that the blade spaces which follow on from one another in the circumferential direction have alternately narrow and wide flow cross sections.

32. The hydrodynamic machine according to claim 16, characterised in that the blade spaces which follow on from one another in the circumferential direction have alternately narrow and wide flow cross sections.

33. The hydrodynamic machine according to claim 17, characterised in that the blade spaces which follow on from one another in the circumferential direction have alternately narrow and wide flow cross sections.
